(19) United States
(12) Patent Application Publication
(10) Pub. No.: US 2025/0291317 A1
(43) Pub. Date: Sep. 18, 2025

(54) Electronically Controlled Mechanical Timepiece

(71) Applicant: SEIKO EPSON CORPORATION, Tokyo (JP)

(72) Inventor: Yutaka YAMAZAKI, Okaya (JP)

(21) Appl. No.: 19/081,294

(22) Filed: Mar. 17, 2025

(30) Foreign Application Priority Data
Mar. 18, 2024 (JP) 2024-042013

(51) Int. Cl. G04C 3/10; G04C 3/12

(52) U.S. Cl. CPC G04C 3/108; G04C 3/12

(57) ABSTRACT

An electronically controlled mechanical timepiece includes: a mainspring; a train wheel that transmits mechanical energy of the mainspring; hands; a governor; a controller that controls the governor; a generator that converts the mechanical energy into electric energy; first and second power storage devices that stores electric energy; and a connection circuit that connects the first and second power storage devices in parallel. The connection circuit is switched to: a first state, in a first case, in which the first and second power storage devices are connected; a second state, in a second case, in which the first and second power storage devices are connected in a state in which an amount of electric charge transfer per unit time is smaller than that in the first state; and a third state, in a third case, in which the first and second power storage devices are disconnected from each other.

The present application is based on, and claims priority from JP Application Serial Number 2024-042013, filed Mar. 18, 2024, the disclosure of which is hereby incorporated by reference herein in its entirety.

### BACKGROUND

### 1. Technical Field

The present disclosure relates to an electronically controlled mechanical timepiece.

### 2. Related Art

An electronically controlled mechanical timepiece is known in which electric energy generated by driving a generator by mechanical energy when a mainspring is opened is accumulated in a first power storage device, and a rotation control device is driven by the electric energy supplied from the first power storage device to control a rotation cycle of the generator, thereby accurately driving hands operating by a train wheel and accurately displaying time (see JP-A-2000-214271).

In the electronically controlled mechanical timepiece disclosed in JP-A-2000-214271, an additional power supply device is provided that includes an additional generator such as a solar generating device and a second power storage device, and electric energy is supplied from the additional power supply device when a voltage of the first power storage device drops, thereby extending a duration.

The electronically controlled mechanical timepiece disclosed in JP-A-2000-214271 has a problem in that since the additional power supply device including the additional generator and the like is provided in addition to the generator that generates electricity with mechanical energy, movement of the timepiece becomes larger in size.

### SUMMARY

An electronically controlled mechanical timepiece of the present disclosure includes: a mainspring; a train wheel that transmits mechanical energy of the mainspring; hands that are driven by the train wheel and displays time; a governor that controls a rotation cycle of the train wheel; a controller that controls the governor; a generator that converts the mechanical energy into electric energy; a first power storage device that stores electric energy of the generator and supplies the electric energy to the controller; a second power storage device that stores electric energy; and a connection circuit that connects the first power storage device and the second power storage device in parallel. The connection circuit is switched to: a first state, in a first case, in which the first power storage device and the second power storage device are connected; a second state, in a second case different from the first case, in which the first power storage device and the second power storage device are connected in a state in which an amount of electric charge transfer per unit time is smaller than that in the first state; and a third state, in a third case different from the first and second cases, in which the first power storage device and the second power storage device are disconnected from each other.

### BRIEF DESCRIPTION OF THE DRAWINGS

FIG. 1 is a front view showing an electronically controlled mechanical timepiece according to a first embodiment.

FIG. 2 is a block diagram showing a configuration of the electronically controlled mechanical timepiece according to the first embodiment.

FIG. 3 is a circuit diagram showing a connection circuit and power storage devices according to the first embodiment.

FIG. 4A is a diagram showing a PMOS transistor of a switch according to the first embodiment.

FIG. 4B is a diagram showing an NMOS transistor of a switch according to the first embodiment.

FIG. 5A is a graph showing a relationship between a gate voltage and a drain current of an MOSFET according to the first embodiment.

FIG. 5B is a semi-logarithmic graph showing a relationship between the gate voltage and the drain current of the MOSFET according to the first embodiment.

FIG. 6 is a circuit diagram showing a gate input signal generation circuit of the connection circuit according to the first embodiment.

FIG. 7 is a diagram showing detection signals for switch control and states of switches according to the first embodiment.

FIG. 8 is a graph showing changes in voltage of a first power storage device and a second power storage device according to the first embodiment.

FIG. 9 is a block diagram showing a configuration of an electronically controlled mechanical timepiece according to a second embodiment.

FIG. 10 is a circuit diagram showing a connection circuit and power storage devices according to the second embodiment.

FIG. 11 is a diagram showing detection signals for switch control and states of switches according to the second embodiment.

FIG. 12 is a timing chart showing an oscillation stop detection signal and a switch control signal according to the second embodiment.

FIG. 13 is a graph showing changes in voltage of a first power storage device, a second power storage device, and a third power storage device according to the second embodiment.

### DESCRIPTION OF EMBODIMENTS

### First Embodiment

Hereinafter, an electronically controlled mechanical timepiece 1 according to a first embodiment of the present disclosure will be described with reference to the drawings.

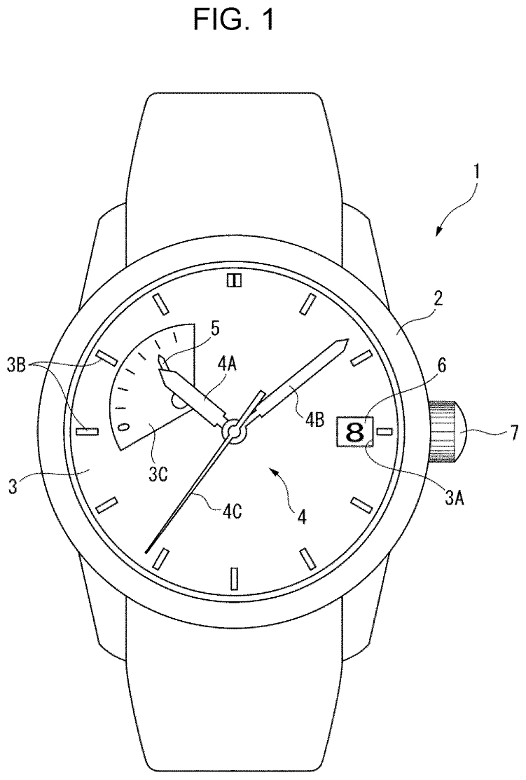

FIG. 1 is a front view showing an electronically controlled mechanical timepiece 1. As shown in FIG. 1, the electronically controlled mechanical timepiece 1 is a wristwatch worn on n a user's wrist, and includes a cylindrical exterior case 2, and a dial 3 is disposed on an inner peripheral side of the exterior case 2. In two openings of the exterior case 2, the opening on a front surface side is closed with a cover glass, and the opening on a back surface side is closed with a case back.

The electronically controlled mechanical timepiece 1 includes a movement (not shown) housed in the exterior case 2, and hands 4 for displaying time information. The hands 4 include an hour hand 4A, a minute hand 4B, and a second hand 4C. The dial 3 is provided with a calendar small-window 3A, and a date indicator 6 can be visually recognized from the calendar small-window 3A. The dial 3 also includes an hour mark 3B for indicating the time and a fan-shaped subdial 3C for indicating a duration with a power reserve hand 5.

A crown 7 is provided on a side surface of the exterior case 2. The crown 7 can be pulled out and moved to a first step position and a second step position from a zero step position at which the crown 7 is pushed toward a center of the electronically controlled mechanical timepiece 1.

When the crown 7 is pulled out to the first step position and rotated, the date indicator 6 can move to adjust the date. When the crown 7 is pulled to the second step position, the second hand 4C stops, and when the crown 7 is rotated at the second step position, the hour hand 4A and the minute hand 4B can move to adjust the time. A method of correcting the date indicator 6, the hour hand 4A, and the minute hand 4B using the crown 7 is the same as that of a timepiece according to the related art, and thus will not be described.

### Schematic Configuration of Timepiece

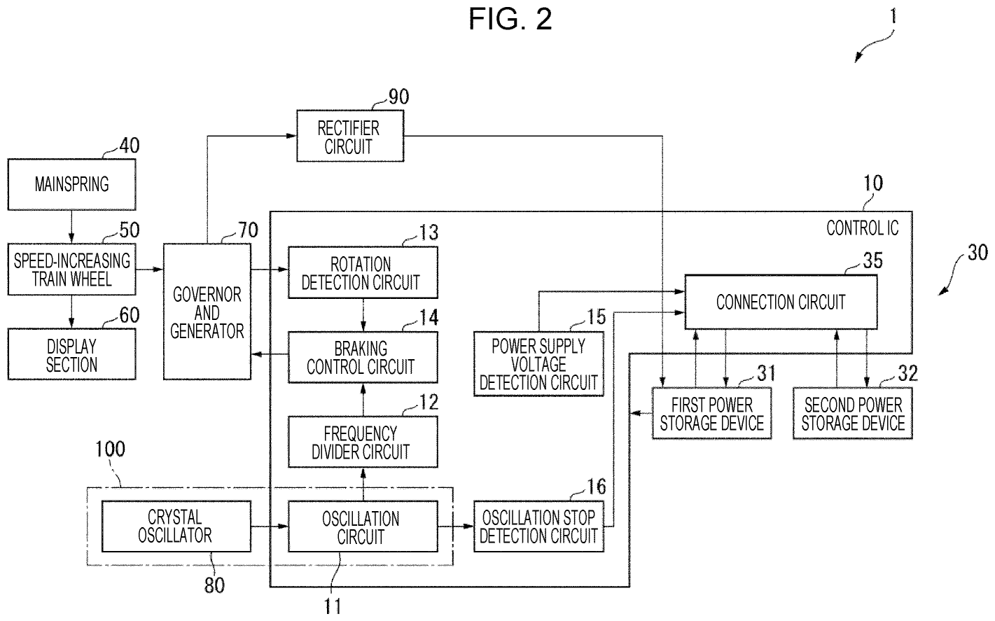

FIG. 2 is a block diagram showing a configuration of the electronically controlled mechanical timepiece 1.

As shown in FIG. 2, the electronically controlled mechanical timepiece 1 includes a control IC 10 as a controller, a mainspring 40 as a mechanical energy source, a speed-increasing train wheel 50 as an energy transmission device for transmitting a torque of the mainspring 40, a display section 60 connected to the speed-increasing train wheel 50 to display the time, a generator 70 driven by the torque transmitted through the speed-increasing train wheel 50 and also serving as a governor of the speed-increasing train wheel 50, a crystal oscillator 80, a rectifier circuit 90, and a power supply circuit 30.

The mainspring 40 is wound via a winding train wheel by manual winding using a crown 7 or automatic winding by an oscillating weight.

The speed-increasing train wheel 50 includes a plurality of gears that rotate with the mechanical energy accumulated in the mainspring 40, and operates the hour hand 4A, the minute hand 4B, and the second hand 4C attached to shafts of these gears. The speed-increasing train wheel 50 is engaged with a pinion of a rotor of the generator 70 to rotate the rotor.

Although not shown in the drawings, a power reserve train wheel is provided which is linked to the winding train wheel that winds the mainspring 40 and the speed-increasing train wheel 50, and the power reserve hand 5 is attached to the power reserve train wheel. The electronically controlled mechanical timepiece 1 of the present embodiment can ensure a duration of approximately 72 hours when the mainspring 40 is fully wound up.

The display section 60 includes the hands 4 and the date indicator 6 shown in FIG. 1, and displays the time.

The generator 70 is an electromagnetic induction generator that includes a coil and a rotor magnetized with two poles and generates electricity by generating an induced voltage due to a change in magnetic flux passing through the coil as the rotor rotates. The rotor is rotated by the speed-increasing train wheel 50, and a rotational speed of the rotor is governed by a short brake using chopping control that intermittently short-circuits both ends of the coil, thereby governing the operating speed of the hands 4 provided on the speed-increasing train wheel 50 and improving the accuracy of the time indication by the hands 4. For this reason, the generator 70 also serves as a governor that governs the operating speed of the speed-increasing train wheel 50, that is, the hands 4.

A brake circuit controlled by a control IC 10 and the rectifier circuit 90 are connected to an output terminal of the coil of the generator 70. Therefore, the electric energy supplied from the generator 70 is charged to the power supply circuit 30 via the rectifier circuit 90.

The brake circuit includes a transistor that short-circuits both ends of the coil in order to cause the generator 70 to function as a governor, short-circuits both ends of the coil to create a closed loop state by performing chopping control that intermittently short-circuits the transistor, and applies a short brake to the generator 70.

The rectifier circuit 90 includes a step-up rectifier, a full-wave rectifier, a half-wave rectifier, a transistor rectifier, or the like, and steps up and rectifies an AC output from the generator 70 to supply the output to the power supply circuit 30 for charging.

### Control IC

As shown in FIG. 2, the control IC 10 includes an oscillation circuit 11, a frequency divider circuit 12, a rotation detection circuit 13, a braking control circuit 14, a power supply voltage detection circuit 15, and an oscillation stop detection circuit 16. Note that IC is an abbreviation for Integrated Circuit.

The oscillation circuit 11 forms a crystal oscillation circuit 100 together with the crystal oscillator 80. The crystal oscillation circuit 100 stops oscillation when an IC applied voltage VDD of the power supply circuit 30 falls below an oscillation stop voltage, and starts oscillation when the IC applied voltage VDD exceeds the oscillation start voltage. The oscillation start voltage may be the same voltage as the oscillation stop voltage, but is preferably set to a voltage higher than the oscillation stop voltage so that the oscillation can be stably continued after the start of oscillation. In addition, since it is necessary for the oscillation circuit 11 to operate, that is, for the control IC 10 to operate in order for the crystal oscillation circuit 100 to start oscillation, the oscillation start voltage may be equal to or higher than an operation start voltage of the control IC 10, and in the present embodiment, the oscillation start voltage and the operation start voltage of the control IC 10 are set to the same voltage. The oscillation stopping voltage is set to a voltage higher than the operation stop voltage of the control IC 10 such that the oscillation circuit 11 stops the oscillation before the control IC 10 stops.

The oscillation circuit 11 outputs an oscillation signal of a predetermined frequency generated by oscillation of the crystal oscillator 80 to the frequency divider circuit 12. In the present embodiment, the oscillation circuit 11 generates an oscillation signal of 32768 Hz. Therefore, the crystal oscillation circuit 100 including the crystal oscillator 80 and the oscillation circuit 11 is an oscillator that outputs a clock signal of the 32768 Hz.

The frequency divider circuit 12 divides the frequency of the output of the oscillation circuit 11 to create clock signals of a plurality of frequencies, and outputs the clock signals necessary for the braking control circuit 14. The clock signal output from the frequency divider circuit 12 to the braking control circuit 14 is a reference signal serving as a reference for rotation control of the rotor of the generator 70. In the present embodiment, since the reference speed of the rotor of the generator 70 is 8 Hz, the frequency divider circuit 12 creates a reference signal of 8 Hz and outputs it to the braking control circuit 14.

The rotation detection circuit 13 includes a waveform shaping circuit (not shown) connected to the generator 70 and a mono-multivibrator (not shown), and outputs a rotation detection signal indicating a rotational frequency, that is, a rotational speed of the rotor from an induced voltage waveform generated in the generator 70 to the braking control circuit 14.

The braking control circuit 14 compares the rotation detection signal output from the rotation detection circuit 13 with the reference signal output from the frequency divider circuit 12, and outputs a braking control signal to a brake circuit of the generator 70 to govern the speed of the generator 70.

In the present embodiment, the reference signal is a signal corresponding to the reference rotation speed of the rotor during a normal hand operation. Therefore, the braking control circuit 14 outputs a braking control signal according to a difference between the rotation detection signal corresponding to the rotational speed of the rotor and the reference signal, thereby adjusting a braking force by the brake circuit and controlling the rotation of the rotor.

The power supply voltage detection circuit 15 is a voltage detector that detects voltages of a first power storage device 31 and a second power storage device 32 of the power supply circuit 30 at a predetermined cycle.

The power supply voltage detection circuit 15 compares the voltage of the first power storage device, which is a detected voltage of the first power storage device 31, with a predetermined first threshold voltage Vdet1, and outputs a first voltage detection signal based on the comparison result. The power supply voltage detection circuit 15 outputs a Low-level signal as the first voltage detection signal when the voltage of the first power storage device is lower than the first threshold voltage Vdet1, and outputs a High-level signal as the first voltage detection signal when the voltage of the first power storage device is equal to or higher than the first threshold voltage Vdet1.

The power supply voltage detection circuit 15 compares the voltage of the second power storage device, which is a detected voltage of the second power storage device 32, with a predetermined second threshold voltage Vdet2, and outputs a second voltage detection signal based on the comparison result. The power supply voltage detection circuit 15 outputs a Low-level signal as the second voltage detection signal when the voltage of the second power storage device is lower than the second threshold voltage Vdet2, and outputs a High-level signal as the second voltage detection signal when the voltage of the second power storage device is equal to or higher than the second threshold voltage Vdet2. The second threshold voltage Vdet2 is set to a voltage equal to or higher than the first threshold voltage Vdet1. Specific values of the first and second threshold voltages Vdet1 and Vdet2 may be appropriately set depending on capacitances of the first power storage devices 31 and the second power storage device 32, the operation start voltage of the control IC 10, and the like.

The oscillation stop detection circuit 16 is an oscillation stop detector that detects the stop of oscillation of the crystal oscillation circuit 100 by monitoring the clock signal output from the oscillation circuit 11. When detecting the stop of oscillation of the crystal oscillation circuit 100, the oscillation stop detection circuit 16 outputs a Low-level control signal for switching a switch 36 to an OFF state regardless of the amount of mechanical energy of the mainspring 40.

When the first power storage device 31 of the power supply circuit 30 is charged from a state in which the control IC 10 is stopped, the control IC 10 starts operating, and the crystal oscillation circuit 100 starts oscillating, the oscillation stop detection circuit 16 outputs a High-level control signal that enables switching of the switch 36 according to the amount of mechanical energy of the mainspring 40.

### Power Supply Circuit

The power supply circuit 30 includes a first power storage device 31, a second power storage device 32, and a connection circuit 35.

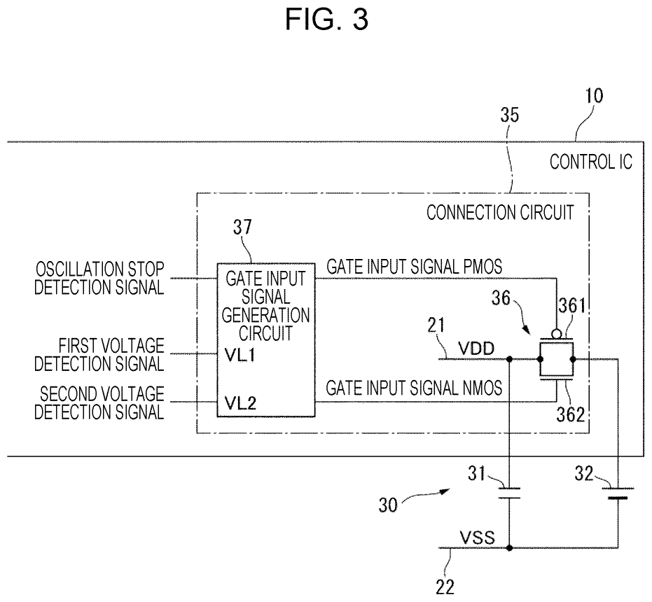

As also shown in FIG. 3, the first power storage device 31 is configured with a capacitor, stores electric charges generated by the generator 70, smoothes the voltage, and supplies the voltage to the control IC 10. Since the first power storage device 31 needs to quickly increase the voltage, the capacitance of the capacitor is set according to the generating capacity of the generator 70.

Since the second power storage device 32 needs to store a large amount of electric charges, a power storage device having a larger capacitance than the first power storage device 31 is selected. Therefore, the second power storage device 32 may be a rechargeable secondary battery such as a lithium-ion battery or an all-solid-state battery, or a large-capacitance capacitor. In particular, when a secondary battery having flat voltage-capacitance characteristics is used as the second power storage device 32, the second power storage device 32 does not become too high in voltage, and can efficiently charge the generated energy. Furthermore, even when an all-solid-state battery having low internal resistance is used as the second power storage device 32, improvement in charging efficiency can be expected.

The first power storage device 31 is directly connected to the rectifier circuit 90, and the second power storage device 32 is connected in parallel to the first power storage device 31 via the connection circuit 35. Therefore, when the connection circuit 35 is controlled to be in the connected state, the first power storage device 31 and the second power storage device 32 are connected in parallel to a first power supply line 21 electrically connected to a VDD terminal of the control IC 10 and a second power supply line 22 electrically connected to a VSS terminal of the control IC 10. When the connection circuit 35 is controlled to be in the OFF state, the second power storage device 32 is disconnected from the first power supply line 21, and only the first power storage device 31 is connected to the first power supply line 21 and the second power supply line 22. Therefore, the connection circuit 35 functions as a switch that connects the second power storage device 32 to the first power storage device 31 in parallel.

In the present embodiment, the second power supply line 22 is set to a ground potential VSS, and the voltage VDD is applied to the control IC 10.

Further, in the present embodiment, the connection circuit 35 is disposed between the first power supply line 21 and the second power storage device 32, but may be disposed between the second power supply line 22 and the second power storage device 32.

As shown in FIG. 3, the connection circuit 35 includes a switch 36 and a gate input signal generation circuit 37 that controls the switch 36, and is controlled by the first voltage detection signal and the second voltage detection signal input from the power supply voltage detection circuit 15 and the oscillation stop detection signal input from the oscillation stop detection circuit 16.

The switch 36 is an analog switch in which a PMOS transistor 361 and an NMOS transistor 362, both of which are MOSFETs, are connected in parallel. MOSFET is an abbreviation for metal-oxide-semiconductor field-effect transistor. When both the PMOS transistor 361 and the NMOS transistor 362 are used for the switch 36, even when the voltages of the first power storage device 31 and the second power storage device 32 change and the direction in which the current flows changes, the switch 36 can efficiently allow the current to flow.

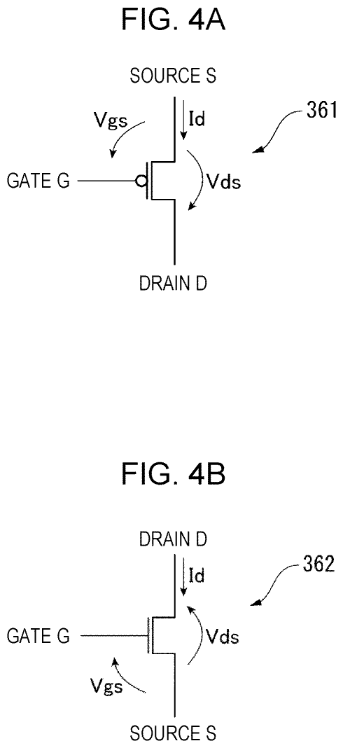

In the PMOS transistor 361, as shown in FIG. 4A, when a Low-level signal is input to a gate G, a voltage of the gate G is made lower than a voltage of a source S, and a gate voltage Vgs, which is a gate-to-source voltage when the source S is used as a reference, becomes equal to or higher than the threshold voltage, a drain current Id flows from the source S to a drain D.

In the NMOS transistor 362, as shown in FIG. 4B, when a High-level signal is input to a gate G, a voltage of the gate G is made higher than a voltage of a source S, and a gate voltage Vgs, which is a gate-to-source voltage when the source S is used as a reference, becomes equal to or higher than the threshold voltage, a drain current Id flows from a drain D to the source S.

In the following description, a control signal input to the gate of the PMOS transistor 361 is referred to as a gate input signal PMOS, and a control signal input to the gate of the NMOS transistor 362 is referred to as a gate input signal NMOS.

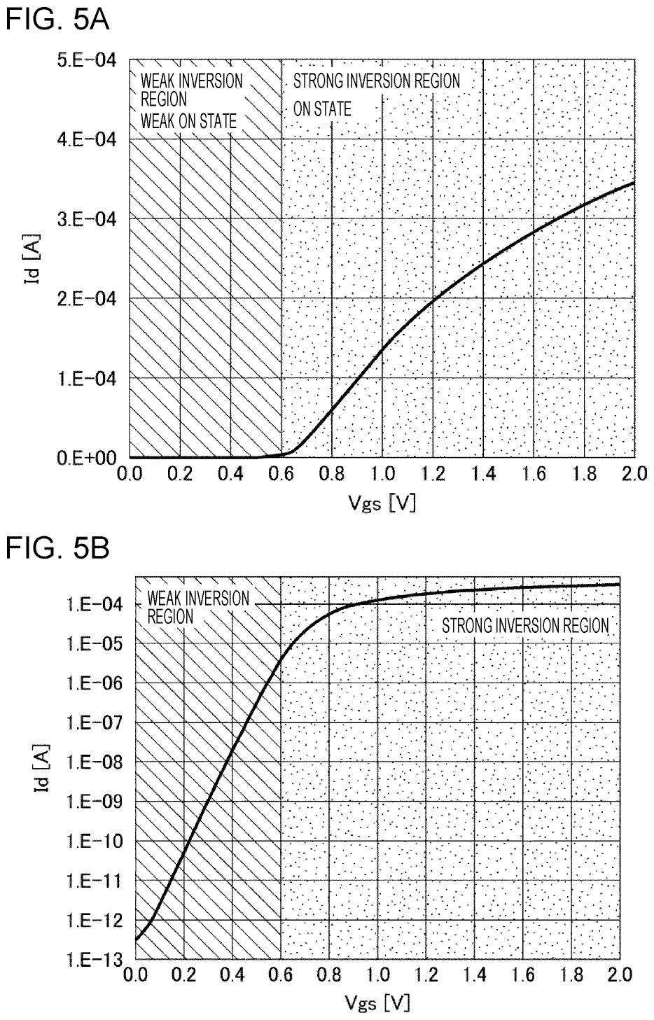

FIG. 5A is a graph showing an example of a relationship between the gate voltage Vgs and the drain current Id in the PMOS transistor 361 and the NMOS transistor 362, and FIG. 5B is a semi-logarithmic graph in which a vertical axis of the drain current Id in FIG. 5A is plotted logarithmically.

In the examples shown in FIGS. 5A and 5B, the threshold voltages Vth of the PMOS transistor 361 and the NMOS transistor 362 are 0.6 V. As shown in FIG. 5A, a region where the voltage Vgs is equal to or lower than the threshold voltage Vth is a weak inversion region where the drain current Id hardly flows, and a region where the voltage Vgs is higher than the threshold voltage Vth is a strong inversion region where the drain current Id flows and increases in proportion to the voltage Vgs.

As shown in FIG. 5B, the drain current Id increases exponentially with respect to the voltage Vgs in the weak inversion region. In the present embodiment, therefore, the drain current Id is approximately 100 μA in the strong inversion region, for example, in the vicinity of the gate voltage Vgs (=1.0 V) at which each of the transistors 361 and 362 enters an ON state. On the other hand, in the present embodiment, the drain current Id is approximately 100 nA, which is approximately 1/1000 of the amount of current when the gate voltage Vgs is 1.0 V, in the weak inversion region, for example, in the vicinity of the gate voltage Vgs (=0.45 V) at which each of the transistors 361 and 362 enters the ON state weakly.

In the present embodiment, since a leakage current of the drain current Id is about 1.0×10−13 A, which is negligibly small, in a strict sense in the vicinity of the gate voltage Vgs (=0 V) at which each of the transistors 361 and 362 enters an OFF state, the current flowing through the switch 36, that is, the amount of electric charge transfer per unit time can be regarded as 0.

Each of numerical value in the graphs of FIGS. 5A and 5B is an example, and changes depending on the size of the transistor and the process.

Therefore, when the switch 36 enters the OFF state to release the connection between the first power storage device 31 and the second power storage device 32, a High-level signal is input as the gate input signal PMOS, and a Low-level signal is input as the gate input signal NMOS. In this state, although a leakage current flows through the switch 36, the leakage current is negligibly small, and thus the switch 36 is in a switch-OFF state in which the first power storage device 31 and the second power storage device 32 are disconnected from each other, such a disconnected state being defined as a third state.

When the switch 36 is turned on to connect the first power storage device 31 and the second power storage device 32, a Low-level signal is input as the gate input signal PMOS, and a High-level signal is input as the gate input signal NMOS. This state is a switch-ON state in which each of the transistors 361 and 362 enters an ON state in the strong inversion region and a predetermined current flows through the switch 36, and such a state is defined as a first state.

When each of the transistors 361 and 362 has characteristics shown in FIG. 5B and the gate voltage Vgs in the first state is about 1.0 V, a current of about 100 μA flows through the switch 36. Therefore, the amount of electric charge transfer per unit time of the switch 36 in the first state is about 100 μC (microcoulombs) when the unit time is one second.

When the current is adjusted by adjustment of the on-resistance of the switch 36, a signal Vsub_p of a voltage value of the weak inversion region level of the PMOS transistor 361 is input as the gate input signal PMOS, and a signal Vsub_n of a voltage value of the weak inversion region level of the NMOS transistor 362 is input as the gate input signal NMOS. When the signal of the weak inversion region level is input, a smaller current can be made to flow as compared with the switch-ON state. Such a state is defined as a weak ON state, that is, a second state. When each of the transistors 361 and 362 has characteristics of FIG. 5B and the gate voltage Vgs in the second state is about 0.45 V, a current of about 100 nA, which is 1/1000 of that in the first state, flows through the switch 36. For this reason, the amount of electric charge transfer per unit time of the switch 36 in the second state is approximately 100 nC (nanocoulombs) when the unit time is one second.

When the switch 36 is set to be in the second state, that is, the weak ON state, a sudden voltage drop in the first power storage device 31 can be prevented when the electric charge accumulated in the first power storage device 31 is transferred to the second power storage device 32. Therefore, the second power storage device 32 can be charged while the voltage of the first power storage device 31 is ensured.

A current flows through the switch 36 in the first state or the second state from one having a higher voltage of the first power storage device 31 and the second power storage device 32 to the other power storage device having a lower voltage.

As shown in FIG. 3, the gate input signal generation circuit 37 includes a node VL1 to which the first voltage detection signal is input, a node VL2 to which the second voltage detection signal is input, a terminal to which the oscillation stop detection signal is input, a terminal from which the gate input signal PMOS is output, and a terminal from which the gate input signal NMOS is output. That is, the gate input signal generation circuit 37 is a circuit that generates the gate input signals PMOS and NMOS to be input to the gates of the PMOS transistor 361 and the NMOS transistor 362, respectively, based on the first voltage detection signal, the second voltage detection signal, and the oscillation stop detection signal. In the following description, the first voltage detection signal may be referred to as a first voltage detection signal VL1, and the second voltage detection signal may be referred to as a second voltage detection signal VL2.

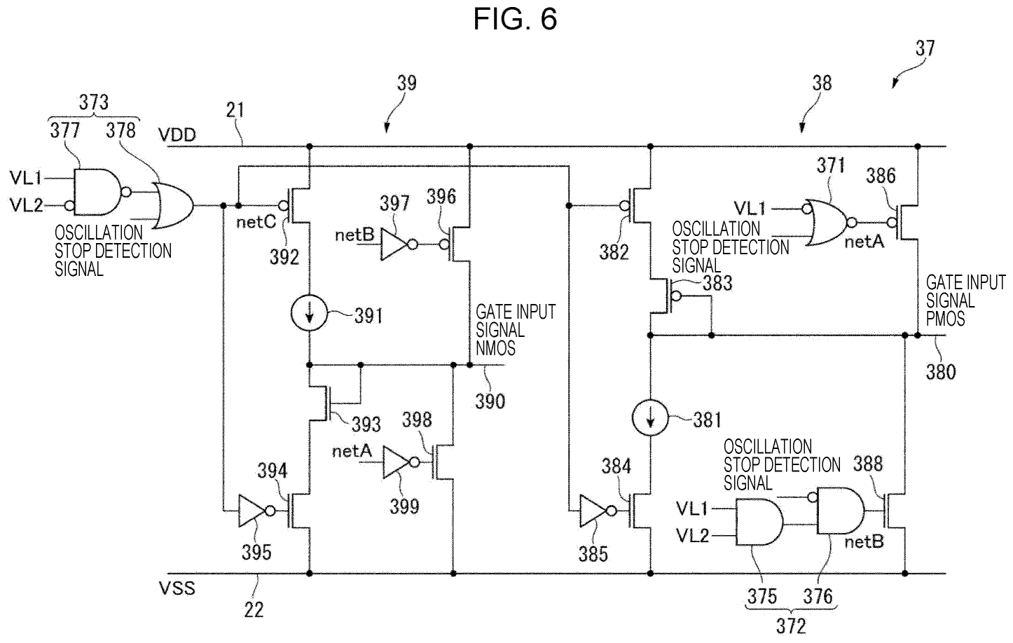

FIG. 6 is a circuit diagram showing the gate input signal generation circuit 37 in detail.

The gate input signal generation circuit 37 includes control signal generation circuits 371, 372, and 373, a first generation circuit 38 that generates a gate input signal PMOS, and a second generation circuit 39 that generates a gate input signal NMOS.

The control signal generation circuit 371 includes a NOR circuit to which an inverted signal of the first voltage detection signal VL1 and the oscillation stop detection signal are input and which outputs a control signal netA.

The control signal generation circuit 372 includes an AND circuit 375 to which the first voltage detection signal VL1 and the second voltage detection signal VL2 are input, and an AND circuit 376 to which an inverted signal of the oscillation stop detection signal and the output of the AND circuit 375 are input and which outputs a control signal netB.

The control signal generation circuit 373 includes a NAND circuit 377 to which an inverted signal of the second voltage detection signal VL2 and the first voltage detection signal VL1 are input, and an OR circuit 378 to which the output of the NAND circuit 377 and the oscillation stop detection signal are input and which outputs a control signal netC.

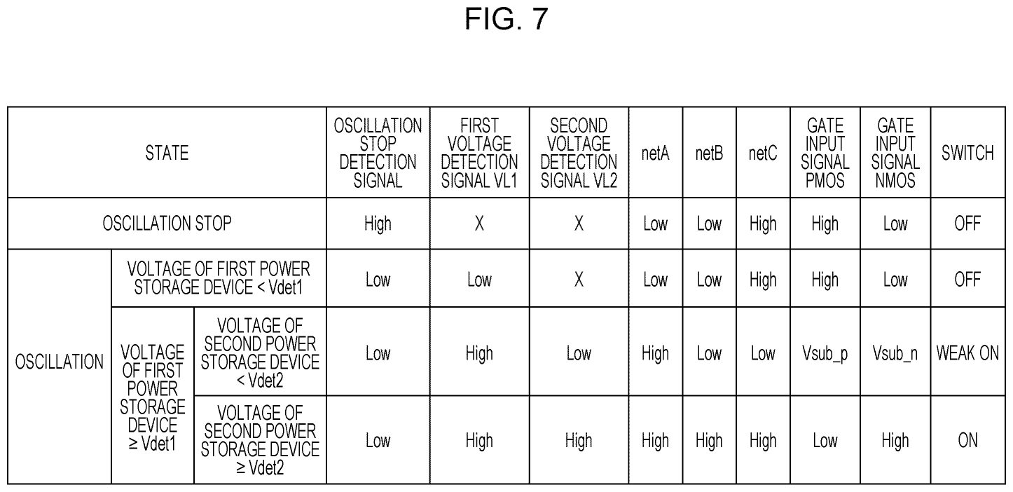

FIG. 7 shows a relationship between the oscillation stop detection signal, the first voltage detection signal VL1, the second voltage detection signal VL2, and the control signals netA, netB, and netC. A symbol “×” in the first voltage detection signal VL1 and the second voltage detection signal VL2 in FIG. 7 means that the signal is at either a High level or a Low level.

As shown in FIG. 7, the control signal netA is at a Low level when the oscillation stop detection signal is at a High level. The control signal netA is also at a Low level when the oscillation stop detection signal is at a Low level and the first voltage detection signal VL1 is at a Low level. The control signal netA is at a High level when the oscillation stop detection signal is at a Low level and the first voltage detection signal VL1 is at a High level.

The control signal netB is at a Low level when the oscillation stop detection signal is at a High level. The control signal netB is also at a Low level when the oscillation stop detection signal is at a Low level and the first voltage detection signal VL1 or the second voltage detection signal VL2 is at a Low level. The control signal netB is at a High level when the oscillation stop detection signal is at a Low level and both the first voltage detection signal VL1 and the second voltage detection signal VL2 are at a High level.

The control signal netC is at a High level when the oscillation stop detection signal is at a High level. The control signal netC is also a High level when the oscillation stop detection signal is at a Low level and the first voltage detection signal VL1 is at a Low level or the second voltage detection signal VL2 is at a High level. The control signal netC is at a Low level when the oscillation stop detection signal and the second voltage detection signal VL2 are at a Low level and the first voltage detection signal VL1 is at a High level.

As shown in FIG. 6, the first generation circuit 38 includes a first constant current circuit 381, a PMOS transistor 382, a PMOS transistor 383, an NMOS transistor 384, a NOT circuit 385, a PMOS transistor 386, an NMOS transistor 388, and an output line 380 connected to the terminal from which the gate input signal PMOS is output.

The PMOS transistor 382 and the PMOS transistor 383 are connected in series between the first power supply line 21 and the first constant current circuit 381. An NMOS transistor 384 is connected between the second power supply line 22 and the first constant current circuit 381. The PMOS transistor 383 is a saturation-connected transistor in which both a gate and a drain are connected to the output line 380.

The control signal netC output from the control signal generation circuit 373 is input to a gate of the PMOS transistor 382, and a signal obtained by inverting the control signal netC in the NOT circuit 385 is input to a gate of the NMOS transistor 384. Therefore, the PMOS transistor 382 and the NMOS transistor 384 enter the OFF state when the control signal netC is a High-level signal, and enter the ON state when the control signal netC is a Low-level signal.

The control signal netA output from the control signal generation circuit 371 is input to the gate of the PMOS transistor 386. Therefore, the PMOS transistor 386 enters the ON state when the control signal netA is a Low-level signal, and enters the OFF state when the control signal netA is a High-level signal.

A control signal netB output from the control signal generation circuit 372 is input to the gate of the NMOS transistor 388. Therefore, the NMOS transistor 388 enters the ON state when the control signal netB is a High-level signal, and enters the OFF state when the control signal netB is a Low-level signal.

The second generation circuit 39 includes a second constant current circuit 391, a PMOS transistor 392, an NMOS transistor 393, an NMOS transistor 394, a NOT circuit 395, a PMOS transistor 396, a NOT circuit 397, an NMOS transistor 398, a NOT circuit 399, and an output line 390 connected to the terminal from which the gate input signal NMOS is output.

The PMOS transistor 392 is connected between the first power supply line 21 and the second constant current circuit 391. The NMOS transistor 393 and the NMOS transistor 394 are connected in series between the second power supply line 22 and the second constant current circuit 391. The NMOS transistor 393 is a saturation-connected transistor in which both a gate and a drain are connected to the output line 390.

The control signal netC output from the control signal generation circuit 373 is input to the gate of the PMOS transistor 392, and a signal obtained by inverting the control signal netC in the NOT circuit 395 is input to the gate of the NMOS transistor 394. Therefore, the PMOS transistor 392 and the NMOS transistor 394 enter the OFF state when the control signal netC is a High-level signal, and enter the ON state when the control signal netC is a Low-level signal.

A signal obtained by inverting the control signal netB output from the control signal generation circuit 372 in the NOT circuit 397 is input to the gate of the PMOS transistor 396. Therefore, the PMOS transistor 396 enters the OFF state when the control signal netB is a Low-level signal, and enters the ON state when the control signal netB is a High-level signal.

A signal obtained by inverting the control signal netA output from the control signal generation circuit 371 in the NOT circuit 399 is input to the gate of the NMOS transistor 398. Therefore, the NMOS transistor 398 enters the ON state when the control signal netA is a Low-level signal, and enters the OFF state when the control signal netA is a High-level signal.

Therefore, as shown in FIG. 7, when the oscillation of the oscillation circuit 11 is stopped and the oscillation stop detection signal output from the oscillation stop detection circuit 16 is a High-level signal, the PMOS transistor 386 enters the ON state and the PMOS transistor 382, the NMOS transistor 384, and the NMOS transistor 388 enter the OFF state in the first generation circuit 38, so that the output line 380 is connected to the first power supply line 21 and the gate input signal PMOS becomes a High-level signal.

In the second generation circuit 39, since the NMOS transistor 398 enters the ON state and the PMOS transistor 392, the NMOS transistor 394, and the PMOS transistor 396 enter the OFF state, the output line 390 is connected to the second power supply line 22 and the gate input signal NMOS becomes a Low-level signal.

Therefore, when the oscillation is stopped, the PMOS transistor 361 and the NMOS transistor 362, that is, the switch 36 is in an OFF state (third state), and the second power storage device 32 is disconnected from the first power storage device 31.

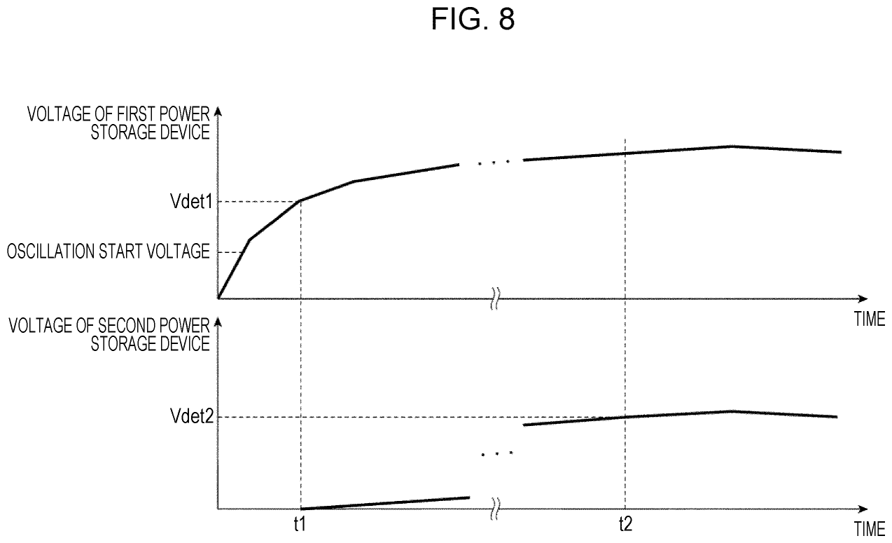

When the oscillation is stopped, since there is no control clock for each circuit, there is a possibility that the state of each circuit is not determined and the switch 36 enters the ON state. However, at this time, since the switch state is determined by the oscillation stop detection signal, the switch 36 can be reliably controlled to be in an OFF state. Since the switch 36 is in the OFF state when the oscillation is stopped, only the first power storage device 31 is charged with electric energy when the generator 70 starts generating, and as shown in FIG. 8, the rising speed of the voltage is faster than when the second power storage device 32 is connected to the first power storage device 31.

When the voltage of the first power storage device 31 rises and exceeds the oscillation start voltage that is equal to or higher than the operation start voltage of the control IC 10, the control IC 10 operates and the crystal oscillation circuit 100 starts oscillating. After the crystal oscillation circuit 100 starts oscillating, when the voltage of the first power storage device 31 is lower than the first threshold voltage Vdet1, the oscillation stop detection signal is at a Low level, the first voltage detection signal VL1 is at a Low level, the gate input signal PMOS is a High-level signal, and the gate input signal NMOS is a Low-level signal, as shown in FIG. 7, so that the switch 36 remains in the OFF state.

When the voltage of the first power storage device 31 rises and becomes equal to or higher than the first threshold voltage Vdet1 at time t1 in FIG. 8, the switch 36 enters the weak ON state (second state). That is, when the oscillation stop detection signal output from the oscillation stop detection circuit 16 is a Low-level signal, when the voltage of the first power storage device 31 is equal to or higher than the first threshold voltage Vdet1 and the first voltage detection signal VL1 is a High-level signal, and when the voltage of the second power storage device 32 is lower than the second threshold voltage Vdet2 and the second voltage detection signal VL2 is a Low-level signal, the PMOS transistor 382 and the NMOS transistor 384 in the first generation circuit 38 enter an ON state, and the PMOS transistor 386 and the NMOS transistor 388 enter an OFF state. Therefore, when the constant current of the first constant current circuit 381 flows through the saturation-connected PMOS transistor 383, the signal Vsub_p having a voltage level between the voltage VDD and the voltage VSS is output from the output line 380 as the gate input signal PMOS.

In the second generation circuit 39, the PMOS transistor 392 and the NMOS transistor 394 enter an ON state, and the PMOS transistor 396 and the NMOS transistor 398 enter an OFF state. Therefore, when the constant current of the second constant current circuit 391 flows through the saturation-connected NMOS transistor 393, the signal Vsub_n having a voltage level between the voltage VDD and the voltage VSS is output from the output line 390 as the gate input signal NMOS.

As the voltage levels of the signal Vsub_p and the signal Vsub_n, when the voltage VSS is used as a reference, for example, Vsub_p is VDD-0.45 V and Vsub_p is 0.45 V. Since the voltages are in the weak inversion regions of the PMOS transistor 361 and the NMOS transistor 362, respectively, the switch 36 enters the weak ON state (second state), and the current flowing through the switch 36 is limited. Therefore, even when the capacitance of the first power storage device 31 is small and the capacitance of the second power storage device 32 is large, as shown in FIG. 8, the voltage of the second power storage device 32 rises while preventing a decrease in the voltage of the first power storage device 31 and ensuring the voltage. The capacitance of the first power storage device 31 is, for example, 5 μF, and the capacitance of the second power storage device 32 is, for example, 2 mAh. However, the capacitances of the first power storage device 31 and the second power storage device 32 are not limited thereto, and the capacitance of the second power storage device 32 may be larger than the capacitance of the first power storage device 31.

However, there may be cases where the generating efficiency decreases due to external factors or variations in the train wheel load, causing a larger outflow of electric charges from the first power storage device 31 and a drop in the voltage of the first power storage device 31, but when the first threshold voltage Vdet is set to a voltage having a margin relative to the oscillation stop voltage, the oscillation circuit 11 does not stop and the switch control can be continued even when the voltage of the first power storage device 31 drops due to the above-described variations.

When the voltage of the second power storage device 32 gradually rises and becomes equal to or higher than the second threshold voltage Vdet2 at time t2, it is determined that the second power storage device 32 is charged with sufficient electric charges, and the switch 36 enters the ON state (first state) as shown in FIG. 7.

The elapsed time from the time t1 to the time t2, during which the second power storage device 32 is charged via the switch 36 being in the weak ON state and the voltage of the second power storage device 32 becomes equal to or higher than the second threshold voltage Vdet2, depends on the capacitance of the second power storage device 32 and the value of the current flowing through the switch 36 being in the weak ON state, but is about 5 to 10 days, for example. In addition, the current value of the switch 36 being in the weak ON state, that is, the amount of electric charge transfer per unit time is set by the voltage values of Vsub_p and Vsub_n input to the gates of the PMOS transistor 361 and the NMOS transistor 362. In other words, to increase the amount of electric charge transfer per unit time of the switch 36, that is, the current, the voltage level of Vsub_p input to the gate of each of the transistors 361 and 362 may be made small and the voltage level of Vsub_n may be made large; conversely, to decrease the current, the voltage level of Vsub_p may be made large and the voltage level of Vsub_n may be made small.

Furthermore, the voltage levels of Vsub_p and Vsub_n may be changed by a change of the magnitude of the constant current from the first constant current circuit 381 and the second constant current circuit 391 or a change of the capacitance of the PMOS transistor 383 and the NMOS transistor 393 that causes the constant current to flow.

Thereafter, when the mainspring torque is large, the electric energy generated by the generator 70 is large, and thus the voltage of the first power storage device 31 is also maintained at a high state, whereby charging from the first power storage device 31 to the second power storage device 32 continues.

When the mainspring torque becomes small, the electric energy generated by the generator 70 decreases, and the voltage of the first power storage device 31 becomes equal to or lower than the voltage of the second power storage device 32, whereby the electric charge is transferred from the second power storage device 32 to the first power storage device 31, and a voltage drop of the first power storage device 31 can be prevented. In other words, even when the mainspring torque becomes small and the mechanical energy required for generating becomes small, the voltage for driving the control IC 10 can be secured, so that the duration can be extended.

### Effect of First Embodiment

According to the electronically controlled mechanical timepiece 1 of the first embodiment, the switch 36 of the connection circuit 35 is controlled according to the first voltage detection signal VL1 and the second voltage detection signal VL2 that detect the voltages of the first power storage device 31 and the second power storage device 32, and the oscillation stop detection signal indicating the oscillation stop state, whereby even when the second power storage device 32 is completely discharged, the voltage of the first power storage device 31 can quickly rise by controlling the switch 36 to the OFF state (third state) until the voltage of the first power storage device 31 exceeds the first threshold voltage Vdet1, and the time can be shortened at which the crystal oscillation circuit 100 is oscillated and the voltage for driving the control IC 10 is secured.

When the voltage of the first power storage device 31 exceeds the first threshold voltage Vdet1, the switch 36 is controlled to the weak ON state (second state) to control the amount of charging to the second power storage device 32, whereby the voltage drop of the first power storage device 31 can be prevented or reduced, and the second power storage device 32 can be charged while maintaining the voltage capable of driving the control IC 10.

Furthermore, when the second power storage device 32 is sufficiently charged, the voltage of the first power storage device 31 is equal to or higher than the first threshold voltage Vdet1, and the voltage of the second power storage device 32 is equal to or higher than the second threshold voltage Vdet2, the switch 36 is controlled to the ON state (first state), whereby the control IC 10 can be driven by the electric energy accumulated in the second power storage device 32 even in the final stage when the mainspring 40 is unwound, and the duration of the electronically controlled mechanical timepiece 1 can be extended.

The electronically controlled mechanical timepiece 1 includes the generator 70 that generates electric power using the mechanical energy of the mainspring 40, and the generator 70 also serves as a governor that governs the speed of the speed-increasing train wheel 50, whereby the volume efficiency of the movement can be improved, and the movement can be reduced in size. Further, it is not necessary to provide another generating section such as an additional generator in order to extend the duration, and also in this respect, the movement can be reduced in size.

### Second Embodiment

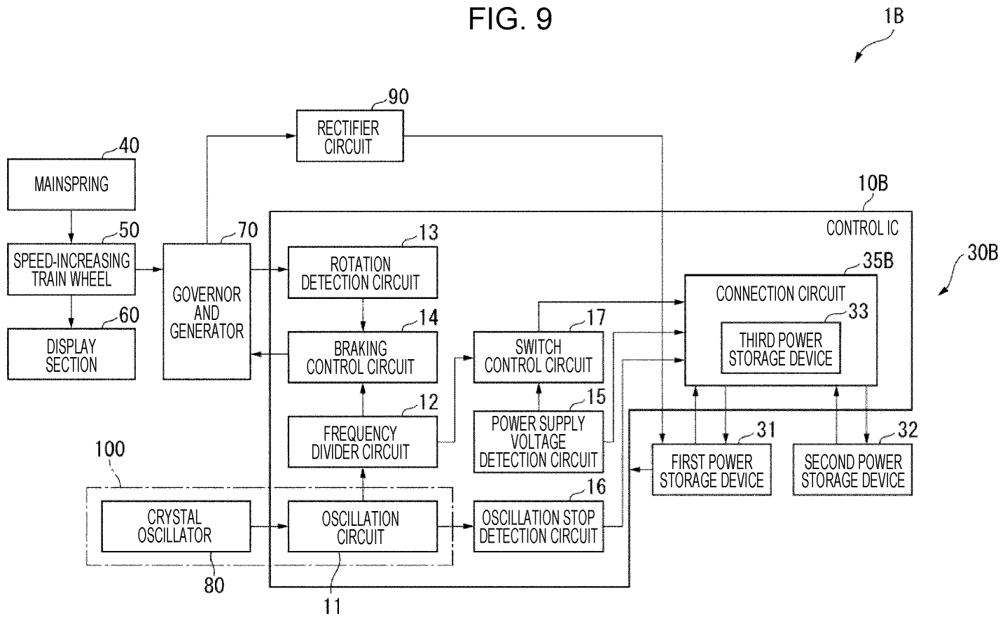

Next, an electronically controlled mechanical timepiece 1B according to a second embodiment will be described with reference to FIGS. 9 to 13.

As shown in FIG. 9, the electronically controlled mechanical timepiece 1B has the same components as those of the first embodiment except for a switch control circuit 17 of a control IC 10B and a connection circuit 35B of a power supply circuit 30B, and thus the same components are denoted by the same reference numerals as in the first embodiment and will not be described.

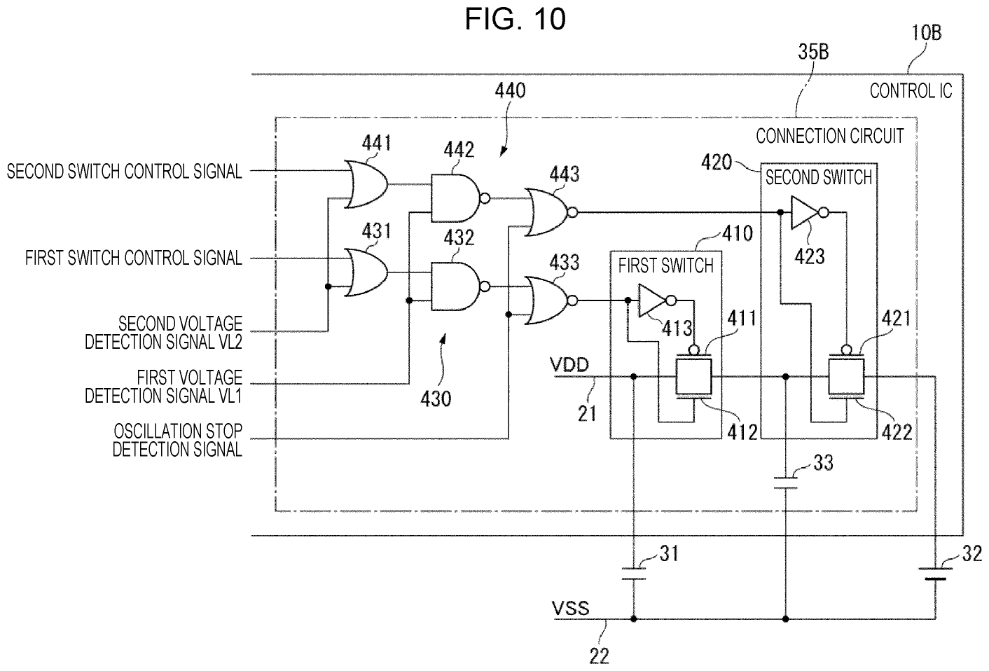

The connection circuit 35B of the power supply circuit 30B is provided in the control IC 10B, and includes a first switch 410, a second switch 420, a first logic circuit 430, a second logic circuit 440, and a third power storage device 33, as shown in FIG. 10.

Similarly to the switch 36, the first switch 410 includes an analog switch configured of a PMOS transistor 411 and an NMOS transistor 412 connected in parallel, and a NOT circuit 413. The NOT circuit 413 is connected to a gate of the PMOS transistor 411 and inverts a signal input to the gate of the PMOS transistor 411.

Similarly to the first switch 410, the second switch 420 includes an analog switch configured of a PMOS transistor 421 and an NMOS transistor 422 connected in parallel, and a NOT circuit 423. The NOT circuit 423 is connected to a gate of the PMOS transistor 421 and inverts a signal input to the gate of the PMOS transistor 421.

Since the analog switch of each of the first switch 410 and the second switch 420 is configured such that the PMOS transistor 411 and the NMOS transistor 412 are connected in parallel and the PMOS transistor 421 and the NMOS transistor 422 are connected in parallel as in the first embodiment, the analog switch is designed to have low loss even when the direction of current flow changes.

The third power storage device 33 is a small-capacitance capacitor built into the connection circuit 35B, that is, the control IC 10B. Although the third power storage device 33 can be provided outside the controller IC 10B, wiring efficiency can be improved when the third power storage device 33 is provided inside the controller IC 10B. The third power storage device 33 is connected in parallel to the first power storage device 31 via the first switch 410, and is connected in parallel to the second power storage device 32 via the second switch 420.

The first power storage device 31 is configured with a capacitor as in the first embodiment, and the second power storage device 32 is configured with a secondary battery as in the first embodiment.

Capacitances of the first power storage device 31, the second power storage device 32, and the third power storage device 33 can be set as appropriate depending on implementation. For example, when it is assumed that a constant current can flow even if the voltage changes, an example of a capacitance ratio is as follows. In other words, when the capacitance of the third power storage device 33 is 5 pF and such a capacitance is taken as 1, the capacitance of the first power storage device 31 is about 106 times the capacitance of the third power storage device 33, that is, about 5 μF, and the capacitance of the second power storage device 32 is about 1.5×1012 times the capacitance of the third power storage device 33, that is, about 2 mAh.

The first logic circuit 430 is a circuit that controls the first switch 410, and includes an OR circuit 431, a NAND circuit 432, and a NOR circuit 433.

A first switch control signal output from the switch control circuit 17 and a second voltage detection signal VL2 are input to the OR circuit 431. The output of the OR circuit 431 and a first voltage detection signal VL1 are input to the NAND circuit 432. The output of the NAND circuit 432 and the oscillation stop detection signal are input to the NOR circuit 433. The output of the NOR circuit 433 is input to the first switch 410. That is, the output of the NOR circuit 433 is input to the gate of the NMOS transistor 412, and is input to the gate of the PMOS transistor 411 by being inverted by the NOT circuit 413.

The second logic circuit 440 is a circuit that controls the second switch 420, and includes an OR circuit 441, a NAND circuit 442, and a NOR circuit 443, similarly to the first logic circuit 430.

A second switch control signal output from the switch control circuit 17 and the second voltage detection signal VL2 are input to the OR circuit 441. The output of the OR circuit 441 and a first voltage detection signal VL1 are input to the NAND circuit 442. The output of the NAND circuit 442 and the oscillation stop detection signal are input to the NOR circuit 443. The output of the NOR circuit 443 is input to the second switch 420. That is, the output of the NOR circuit 443 is input to the gate of the NMOS transistor 422, and is input to the gate of the PMOS transistor 421 by being inverted by the NOT circuit 423.

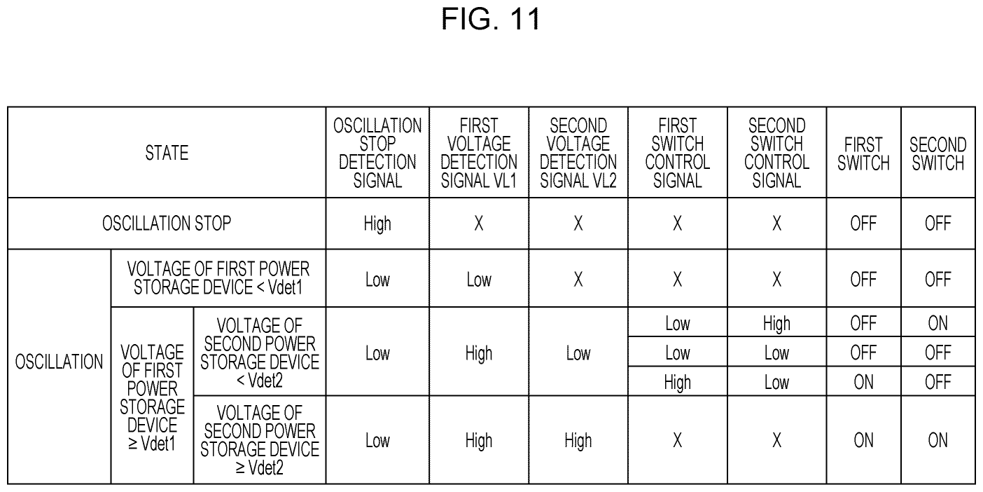

FIG. 11 is a diagram showing a relationship between the oscillation stop detection signal, the first voltage detection signal VL1, the second voltage detection signal VL2, the first switch control signal, the second switch control signal, and states of the first switch 410 and the second switch 420.

When the oscillation stop detection circuit 16 detects the stop of oscillation of the crystal oscillation circuit 100 and the oscillation stop detection signal is at a High level, both the first switch 410 and the second switch 420 enter an OFF state, and are controlled to a third state in which the first power storage device 31 and the third power storage device 33 are disconnected from each other. In the oscillation stop state, therefore, only the first power storage device 31 is charged with the electric charge supplied from the generator 70 via the rectifier circuit 90, and the rising speed of the voltage can be ensured.

When the voltage of the first power storage device 31 rises and reaches the oscillation start voltage of the crystal oscillation circuit 100, which is equal to or higher than an operation start voltage of the control IC 10B, the crystal oscillation circuit 100 starts oscillating, and since the voltage of the first power storage device 31 is lower than the first threshold voltage Vdet1 in a state where the control IC 10B starts operating, the first switch 410 and the second switch 420 remain in the OFF state (third state).

When the voltage of the first power storage device 31 further rises to be equal to or higher than the first threshold voltage value Vdet1 and the voltage of the second power storage device 32 is lower than the second reference value Vdet2, the first switch 410 and the second switch 420 are controlled by the first switch control signal and the second switch control signal input from the switch control circuit 17.

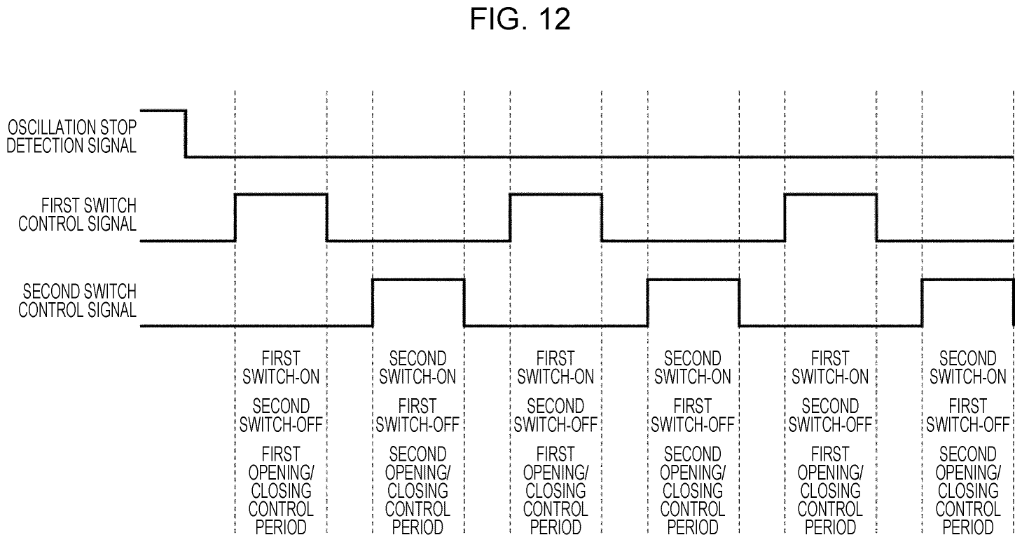

The first switch 410 enters an ON state when the first switch control signal is at a High level, and enters an OFF state when the first switch control signal is at a Low level. Similarly, the second switch 420 enters an ON state when the second switch control signal is at a High level, and enters an OFF state when the second switch control signal is at a Low level. Then, as shown in FIG. 12, the switch control circuit 17 outputs the first switch control signal and the second switch control signal when the oscillation of the crystal oscillation circuit 100 is started, that is, when the oscillation stop detection signal becomes Low level. At this time, the switch control circuit 17 outputs each control signal so that there is no period during which both of the first switch control signal and the second switch control signal are at a High level. For this reason, a first opening/closing control period and a second opening/closing control period alternately occur with a switch-off period interposed therebetween, the first opening/closing control period being controlled to a first opening/closing state in which the first switch 410 enters an ON state and the second switch 420 enters an OFF state, the second opening/closing control period being controlled to a second opening/closing state in which the first switch 410 enters an OFF state and the second switch 420 enters an On state, the switch-off period being in an OFF state in which both the first switch 410 and the second switch 420 are disconnected from each other and enter an OFF state. A frequency at which the first switch 410 and the second switch 420 are turned on and off can be set as appropriate, and is 4 kHz, for example. The amount of electric charge that transfers from the first power storage device 31 to the second power storage device 32 via the third power storage device 33 per unit time or the amount of electric charge that transfers from the second power storage device 32 to the first power storage device 31 via the third power storage device 33 per unit time, that is, the average value of current that flows per unit time, is changed by the frequency at which each of the switches 410 and 420 is turned on and off.

During the first opening/closing control period, since the first switch 410 is in the ON state and the second switch 420 is in the OFF state, the electric charge accumulated in the first power storage device 31 transfers to the third power storage device 33. At this time, since the capacitance of the third power storage device 33 is smaller than the capacitance of the first power storage device 31, the amount of electric charge transfer to the third power storage device 33 is small, and the voltage drop of the first power storage device 31 is small.

Next, a switch-off period begins, and the first switch 410 and the second switch 420 enter the OFF state, whereby the first power storage device 31 and the third power storage device 33 are disconnected from each other, and the electric charges accumulated in the third power storage device 33 is preserved.

Next, a second opening/closing control period begins, the second switch 420 enters the ON state, and the first switch 410 enters the OFF state, whereby some of the electric charges accumulated in the third power storage device 33 is transferred to the second power storage device 32. At this time, since the capacitance of the third power storage device 33 is significantly smaller than the capacitance of the second power storage device 32, the voltage of the third power storage device 33 significantly drops depending on the voltage of the second power storage device 32. However, since the first switch 410 is in the OFF state and the connection between the first power storage device 31 and the third power storage device 33 is released, the voltage of the first power storage device 31 is not affected.

Thereafter, the first opening/closing control period and the second opening/closing control period are alternately and repeatedly executed with the switch-off period interposed therebetween.

As described above, the first opening/closing control and the second opening/closing control are alternately executed, and thus the electric charges accumulated in the first power storage device 31 can be transferred little by little to the high-capacitance second power storage device 32 via the third power storage device 33. Therefore, the amount of electric charge transfer per unit time between the first power storage device 31 and the second power storage device 32 is smaller than that in the first state in which both the first switch 410 and the second switch 420 are in the ON state. Therefore, during a period in which the first opening/closing control period and the second opening/closing control period are alternately and repeatedly executed, the second state similar to the weak ON state in the first embodiment is established, and the second power storage device 32 can be charged while maintaining the voltage of the first power storage device 31.

Here, as in the first embodiment, the first threshold voltage Vdet1 is set to a voltage that is relatively higher than the oscillation stop voltage, i.e., a voltage with a margin, depending on a decrease in generating efficiency due to external factors or the like, the capacitance ratio between the first power storage device 31 and the third power storage device 33, or the like.

In the second embodiment, since the switch-off period is provided between the first opening/closing control period and the second opening/closing control period, in which the first power storage device 31 and the second power storage device 32 are disconnected and the third power storage device 33 and the second power storage device 32 are also disconnected, even when a delay in the signal for controlling the connection between the second power storage device 32 and the third power storage device 33 occurs due to routing of wiring within the control IC 10B, it is possible to prevent the first power storage device 31 and the second power storage device 32 from being electrically connected, that is, to prevent the first switch 410 and the second switch 420 from entering the ON state simultaneously.

When the voltage further rises and the voltage of the second power storage device 32 becomes equal to or higher than the second threshold voltage Vdet2, the first switch 410 and the second switch 420 are both in the ON state as shown in FIG. 11, that is, the first state in which the first power storage device 31, the second power storage device 32, and the third power storage device 33 are connected, regardless of the switch control signal.

Thereafter, when the mainspring torque is large, charging is continued from the first power storage device 31 to the second power storage device 32 via the third power storage device 33.

When the mainspring torque becomes small, the electric charges transfers from the second power storage device 32 to the first power storage device 31 via the third power storage device 33, and the voltage drop in the first power storage device 31 can be prevented. In other words, even when the mainspring torque becomes smaller and the mechanical energy required for generating becomes smaller, the voltage for driving the control IC 10B can be secured, and the duration can be extended.

With the above-described configuration, even when the second power storage device 32 is completely discharged, the amount of charging to the second power storage device 32 via the third power storage device 33 can be controlled, and the time required to secure a voltage sufficient to drive the control IC 10B can be shortened.

Further, since it is possible to recharge not only the first power storage device 31 but also the second power storage device 32 when the generator 70 starts generating by winding of the mainspring 40, even in the end stage when the mainspring 40 is unwound, the electric charges accumulated in the second power storage device 32 can be transferred to the first power storage device 31 to drive the control IC 10B, and thus the effect can be achieved once again in which the duration can be extended.

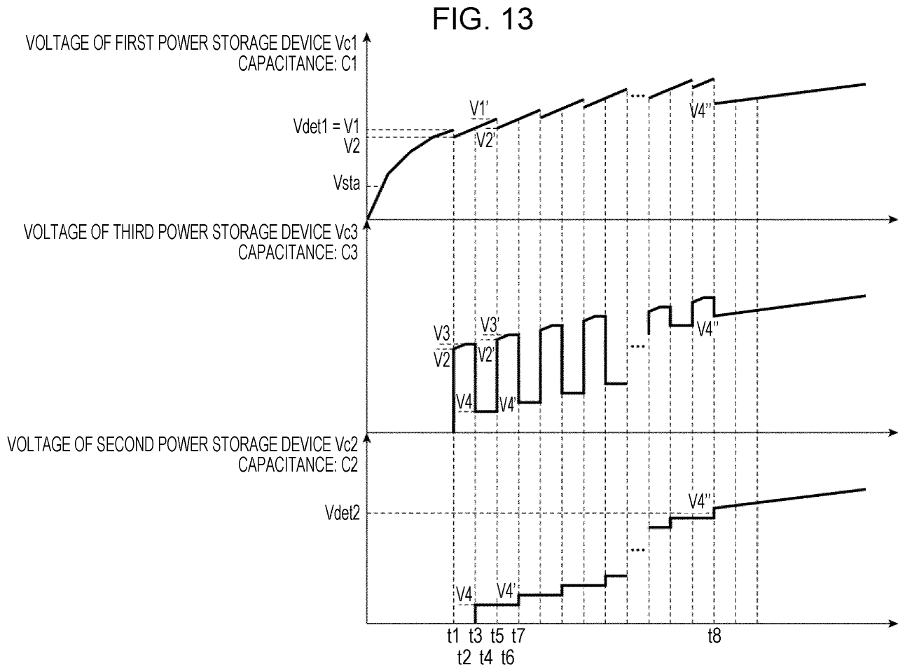

Next, changes in the voltages of the first power storage device 31, the second power storage device 32, and the third power storage device 33 in the second embodiment will be described with reference to FIG. 13.

When the generator 70 starts generating in a state where the first power storage device 31, the second power storage device 32, and the third power storage device 33 are discharged, the voltage Vc1 of the first power storage device 31 rises. When the voltage Vc1 exceeds a oscillation start voltage Vsta of the control IC 10B and further becomes equal to or higher than the first threshold voltage Vdet1, the on/off control of the first switch 410 and the second switch 420 starts.

At time t1 at which the voltage Vc1 of the first power storage device 31 is equal to or higher than the first threshold voltage Vdet1, the first switch 410 enters an ON state, and the first power storage device 31 and the third power storage device 33 are connected to each other. A voltage V2 of the first power storage device 31 and the third power storage device 33 at this time is expressed by Formula (1) below. In Formula (1), V1 represents the voltage of the first power storage device 31 immediately before the first switch 410 is turned on, C1 represents the capacitance of the first power storage device 31, and C3 represents the capacitance of the third power storage device 33.

$$V 2 = \{ C 1 / ( C 1 + C 3 ) \} V 1 \qquad ( 1 )$$

From time t1 to time t2, the voltages of the first power storage device 31 and the third power storage device 33 rise simultaneously. At time t2, the first switch 410 is turned off, and the connection between the first power storage device 31 and the third power storage device 33 is released. Thereafter, the voltage of the first power storage device 31 rises until time t5 at which the first power storage device 31 is next connected to the third power storage device 33.

At time t3, the second switch 420 is turned on, and the third power storage device 33 and the second power storage device 32 are connected to each other. At this time, a voltage V4 of the third power storage device 33 and the second power storage device 32 is expressed by Formula (2) below. In Formula (2), V3 represents the voltage of the third power storage device 33 immediately before the second switch 420 is turned on, and C2 represents the capacitance of the second power storage device 32. Since the capacitance C2 of the second power storage device 32 is much larger than the capacitance C3 of the third power storage device 33, the voltage of the third power storage device 33 immediately drops significantly, and the second power storage device 32 and the third power storage device 33 become the same voltage V4.

$$V4 = \{ C 3 / ( C 3 + C 2 ) \} V 3 \qquad ( 2 )$$

At time t4, the second switch 420 is turned off, and the connection between the third power storage device 33 and the second power storage device 32 are released.

At time t5, the first switch 410 is turned on, and the first power storage device 31 and the third power storage device 33 are connected to each other again. At this time, a voltage V2′ of the first power storage device 31 and the third power storage device 33 is expressed by Formula (3) below. In Formula (3), V1′ represents the voltage of the first power storage device 31 immediately before the first switch 410 is turned on, and V4 represents the voltage of the third power storage device 33.

$${V 2}^{′} = \{ C 1 / ( C 1 + C 3 ) \} V {1}^{′} \{ C 3 / ( C 1 + C 3 ) \} V4 \qquad ( 3 )$$

The voltages of the first power storage device 31 and the third power storage device 33 rise simultaneously until time t6.

At time t6, the first switch 410 is turned off, and the connection between the first power storage device 31 and the third power storage device 33 is released. Thereafter, the voltage of the first power storage device 31 rises until the time when the first power storage device 31 is next connected to the third power storage device 33.

At time t7, the second switch 420 is turned on, and the third power storage device 33 and the second power storage device 32 are connected to each other. At this time, a voltage V4′ of the third power storage device 33 and the second power storage device 32 is expressed by Formula (4) below. In Formula (4), V3′ represents the voltage of the third power storage device 33 immediately before the second switch 420 is turned on, and V4 represents the voltage of the second power storage device 32.

$${V4}^{′} = \{ C 3 / ( C 3 + C 2 ) \} V {3}^{′} + \{ C 2 / ( C 3 + C 2 ) \} V4 \qquad ( 4 )$$

Thereafter, the switch control is repeated similarly to the switch control at each of the times t4 to t7, and thus the voltage of the second power storage device 32 gradually rises.

At time t8, when the voltage of the second power storage device 32 rises to V4″ and exceeds the second threshold voltage Vdet2, the first switch 410 and the second switch 420 are simultaneously turned on, all of the power storage devices 31 to 33 are connected, and the voltages of all of the power storage devices 31 to 33 simultaneously rise.

Thereafter, when the mainspring 40 is unwound and reaches the end stage, the voltage of the first power storage device 31 drops, but the electric charges accumulated in the second power storage device 32 transfer to the first power storage device 31 and compensates for the voltage drop in the first power storage device 31. Thus, it is possible to postpone the stopping of the speed governing of the control IC 10B, and thus to extend the duration of the electronically controlled mechanical timepiece 1B.

### Effects of Second Embodiment

The electronically controlled mechanical timepiece 1B of the second embodiment can also achieve the same effects as the electronically controlled mechanical timepiece 1 of the first embodiment.

Furthermore, since the second state, which is the weak ON state, can be implemented only by controlling the ON and OFF cycles of the first switch 410 and the second switch 420, the control circuit for the first switch 410 and the second switch 420 can be easily configured.

### Modification Examples

The present disclosure is not limited to the above-described embodiments, and the present disclosure may include modifications, improvements, and the like within a scope in which the object of the present disclosure can be achieved.

For example, the amount of electric charge transfer per unit time during the weak ON state, which is the second state, may be controlled so as to be changeable according to the electric energy generated by the generator 70. For example, when the electric energy of the generator 70 is large, that is, when the mechanical energy accumulated in the mainspring 40 is large, the rising speed of the voltage of the first power storage device 31 becomes faster, but when the difference with the induced voltage during generating becomes small, the generating efficiency decreases. Therefore, when the electric energy of the generator 70 is large, the amount of electric charge transfer per unit time during the weak ON state is increased to reduce the rising speed in the voltage of the first power storage device 31, whereby the amount of charging to the second power storage device 32 can be increased and the generating efficiency of the generator 70 can be improved.

In the first embodiment, it is possible to change the amount of electric charge transfer per unit time by adjusting the level of the voltages input to the gates of the PMOS transistor 361 and the NMOS transistor 362 of the switch 36. To increase the amount of electric charge transfer per unit time, the gate voltage Vgs, which is the voltage between the gate and the source when the source is used as a reference, is made large, whereas to decrease the amount of electric charge transfer per unit time, the gate voltage Vgs is made small. In addition, the level of the voltage input to the gate of each of the transistors 361 and 362 may be changed by a method of variably changing the constant current of the first constant current circuit 381 and the second constant current circuit 391, changing the capacity of the PMOS transistor 383 and the NMOS transistor 393 which cause the constant current to flow.

In the second embodiment, it is possible to change the amount of electric charge transfer per unit time by adjusting the frequencies of the first switch control signal and the second switch control signal. To increase the amount of electric charge transfer per unit time, the frequency of each of the switch control signals may be made large, whereas to decrease the amount of electric charge transfer per unit time, the frequency of each of the switch control signals may be made small. In order to change the frequency of each of the switch control signals, the frequency of a clock for generating the switch control signal may be changed.

Since the electric energy of the generator 70 is proportional to the mechanical energy of the mainspring 40 that rotates the rotor of the generator 70, the electric energy of the generator 70 can also be detected by detection of the amount of braking of the rotor by the braking control circuit 14. In other words, when the braking amount is large, the mechanical energy transmitted to the generator 70 is also large, and thus it can be detected that the electric energy of the generator 70 is large; whereas when the braking amount is small, it can be detected that the electric energy of the generator 70 is small.

Not only when the oscillation stops, but also when it is detected that the mainspring 40 is unwound and the train wheel stops, the first power storage device 31 and the second power storage device 32 may be disconnected by setting the connection circuit 35 or the 35B to the third state. Thus, it is possible to prevent the second power storage device 32 from being discharged when the operation of the hands of the electronically controlled mechanical timepiece 1 or 1B is stopped.

The connection state between the first power storage device 31 and the second power storage device 32 by the connection circuit 35 is not limited to being switchable to three states of the first state which is the ON state, the second state which is the weak ON state, and the third state which is the disconnected state, and may be configured to be switchable to four or more states. For example, the gate voltage Vgs of the MOSFET having the characteristics of FIGS. 5A and 5B may be input at a plurality of levels such as 0.7 V, 0.8 V, and 1.0 V, which are the strong inversion region, and the drain current may be changed in multiple steps in strong the inversion region; alternatively, the gate voltage Vgs of the MOSFET may be input at a plurality of levels such as 0.2 V, 0.4 V, and 0.5 V, which are the weak inversion region, and the drain current may be changed in multiple steps in the weak inversion region.

In the connection circuit 35B of the second embodiment, the switch-off period is provided between the first opening/closing control period and the second opening/closing control period, but the switch-off period may not be provided.

The above-described embodiments are applied to the electronically controlled mechanical timepiece 1 in which the rotor of the generator 70, which also serves as the governor, rotates using the mechanical energy from the mainspring 40, and the rotational speed of the rotor is subjected to the speed governing control to control the operating speed of each of the hands 4, but are not limited thereto. For example, the above-described embodiments may be applied to an electronically controlled mechanical timepiece in which, when the speed of the train wheel, which transmits the mechanical energy from the mainspring 40, is governed using an escape wheel, a pallet fork, and a balance wheel, the vibration of the balance wheel is detected to govern the operation of the balance wheel.

### Summary

An electronically controlled mechanical timepiece of the present disclosure includes: a mainspring; a train wheel that transmits mechanical energy of the mainspring; hands that are driven by the train wheel and displays time; a governor that controls a rotation cycle of the train wheel; a controller that controls the governor; a generator that converts the mechanical energy into electric energy; a first power storage device that stores electric energy of the generator and supplies the electric energy to the controller; a second power storage device capable of storing electric energy; and a connection circuit capable of connecting the first power storage device and the second power storage device in parallel, the connection circuit being switchable to at least three states of: a first state in which the first power storage device and the second power storage device are connected; a second state in which the first power storage device and the second power storage device are connected in a state in which an amount of electric charge transfer per unit time is smaller than that in the first state; and a third state in which the first power storage device and the second power storage device are disconnected from each other.

According to the electronically controlled mechanical timepiece of the present disclosure, since the connection circuit capable of connecting the first power storage device and the second power storage device in parallel can be switched to three states of the first state, the second state, and the third state, the state of the connection circuit can be selected according to the winding state of the mainspring or the charging state of each of the power storage devices. Therefore, in a state where each of the power storage devices is discharged, the connection circuit can be set to the third state, whereby only the first power storage device is connected to the generator for charging, the voltage of the first power storage device can rise in a short time, and the time until the controller such as an IC starts the speed governing control can be shortened. In addition, even in a state in which the second power storage device is discharged and the voltage is low, the connection circuit can be set to the second state, whereby the amount of electric charge transfer from the first power storage device to the second power storage device can be adjusted, and the second power storage device having a large capacitance can be charged while preventing the voltage drop in the first power storage device. When the mainspring is unwound and the mechanical energy transmitted to the generator decreases, resulting in a decrease in the electric energy generated by the generator, electric energy can be supplied from the second power storage device to the first power storage device, and thus the voltage level of the first power storage device can be maintained at a voltage at which the controller can operate for a long period of time, whereby the duration can be extended to that extent. Further, it is not necessary to provide an additional generator by addition of the second power storage device and the connection circuit, and thus an increase in size of the movement can also be prevented.

In electronically the controlled mechanical timepiece according to the present disclosure, preferably, the connection circuit is configured to enter the first state when a voltage of the first power storage device is equal to or higher than a first threshold voltage and a voltage of the second power storage device is equal to or higher than a second threshold voltage, enter the second state when the voltage of the first power storage device is equal to or higher than the first threshold voltage and the voltage of the second power storage device is less than the second threshold voltage, and enter the third state when the voltage of the first power storage device is less than the first threshold voltage.

According to the electronically controlled mechanical timepiece of the present disclosure, when the voltage of the first power storage device is low, for example, less than the first threshold voltage, the connection circuit is set to the third state, and only the first power storage device is connected to the generator, whereby the voltage of the first power storage device can rise in a short time. For this reason, even when the mainspring is unwound, the train wheel is stopped, and the controller is also stopped, once the mainspring is wound up, the train wheel starts moving, and the generator starts generating, the controller can also start operating in a short time and can execute the speed governing control.

When the voltage of the first power storage device is equal to or higher than the first threshold voltage and the voltage of the second power storage device is lower than the second threshold voltage, the connection circuit is switched to the second state. Therefore, since the amount of electric charge transfer per unit time, that is, the value of the current flowing through the switch, is limited in the second state, even when the capacitance of the first power storage device is significantly smaller than that of the second power storage device, it is possible to charge the second power storage device while preventing a voltage drop in the first power storage device, and it is also possible for the voltage of the first power storage device to prevent from dropping below the stop voltage of the controller.

When the voltage of the first power storage device is equal to or higher than the first threshold voltage and the voltage of the second power storage device is equal to or higher than the second threshold voltage, the connection circuit is switched to the first state. Since the connection circuit is maintained in the constant connected state in the first state, even when the mainspring is unwound and the generated energy is reduced, the controller can continue to operate using the energy accumulated in the second power storage device, and the duration of the electronically controlled mechanical timepiece can be extended.

In the electronically controlled mechanical timepiece according to the present disclosure, preferably, the connection circuit includes a switch that connects the first power storage device and the second power storage device, the switch is configured by a metal-oxide-semiconductor field-effect transistor, and is capable of adjusting the amount of electric charge transfer depending on a voltage level of a control signal input to a gate of the metal-oxide-semiconductor field-effect transistor, and the voltage level of the control signal input to the gate in the second state is a voltage level in a weak inversion region of the metal-oxide-semiconductor field-effect transistor.

According the electronically to controlled mechanical timepiece of the present disclosure, the amount of electric charge transfer can be adjusted by the voltage input to the gate of the metal-oxide-semiconductor field-effect transistor constituting the switch. At this time, the amount of electric charge transfer can be reduced when the voltage in the weak inversion region is applied compared to when the voltage in the strong inversion region is applied, and the second power storage device can be charged while maintaining the voltage of the first power storage device.

In the electronically controlled mechanical timepiece according to the present disclosure, the connection circuit may include: a third power storage device having a capacitance smaller than that of the first power storage device; a first switch that connects the first power storage device and the third power storage device; and a second switch that connects the third power storage device and the second power storage device, and the second state may be a state in which a first opening/closing state and a second opening/closing state are alternately repeated, the first opening/closing state indicating that the first switch is connected and the second switch is disconnected, the second opening/closing state indicating that the first switch is disconnected and the second switch is connected.

According to the electronically controlled mechanical timepiece of the present disclosure, electric charge can be transferred little by little between the first power storage device and the second power storage device via the third power storage device. Further, the third power storage device having a smaller capacitance than the first power storage device is interposed, whereby the voltage drop in the first power storage device can be reduced when the first switch is connected, and the second power storage device can be charged while maintaining the voltage of the first power storage device.

In the electronically controlled mechanical timepiece according to the present disclosure, preferably, the second state has a period during which both the first switch and the second switch are disconnected from each other, between the first opening/closing state and the second opening/closing state.

According to the electronically controlled mechanical timepiece of the present disclosure, since the period is provided in which both of the switches are simultaneously disconnected, it is possible to prevent a malfunction in which the first power storage device, the second power storage device, and the third power storage device are electrically connected at the same time due to a delay of the signal for controlling connection of the power storage devices caused by routing of wiring in the control IC or the like.

In the electronically controlled mechanical timepiece according to the present disclosure, preferably, the electronically controlled mechanical timepiece further includes: an oscillator that outputs an clock signal; and an oscillation stop detector that detects a stop of the oscillator, and the connection circuit is switched to the third state when the oscillation stop detector detects the stop of the oscillator.

According to the electronically controlled mechanical timepiece of the present disclosure, it is possible to prevent the first power storage device and the second power storage device from being connected to each other due to a malfunction at the time of the low voltage at which the oscillator is stopped and the clock signal for control cannot be generated, and to prevent a decrease in the rising speed of the voltage of the first power storage device during generating of the generator.

In the electronically controlled mechanical timepiece according to the present disclosure, preferably, the electronically controlled mechanical timepiece further includes a detector that detects electric energy generated by the generator, and the connection circuit changes the amount of electric charge transfer per unit time in the second state according to the electric energy detected by the detector.

According to the electronically controlled mechanical timepiece of the present disclosure, when the electric energy generated by the generator is large, it is possible to reduce the rising speed of the voltage of the first power storage device by increasing the amount of electric charge transfer per unit time in the second state and to prevent the difference between the induced voltage of the generator and the voltage of the first power storage device from becoming too small, whereby the generating efficiency can be improved, and the amount of charging to the second power storage device can also be increased.

What is claimed is:

1. An electronically controlled mechanical timepiece comprising:
a mainspring;
a train wheel that transmits mechanical energy of the mainspring;
hands that are driven by the train wheel and displays time;
a governor that controls a rotation cycle of the train wheel;
a controller that controls the governor;
a generator that converts the mechanical energy into electric energy;
a first power storage device that stores electric energy of the generator and supplies the electric energy to the controller;
a second power storage device that stores electric energy; and
a connection circuit that connects the first power storage device and the second power storage device in parallel, wherein
the connection circuit is switched to:
a first state, in a first case, in which the first power storage device and the second power storage device are connected;
a second state, in a second case different from the first case, in which the first power storage device and the second power storage device are connected in a state in which an amount of electric charge transfer per unit time is smaller than that in the first state; and
a third state, in a third case different from the first and second cases, in which the first power storage device and the second power storage device are disconnected from each other.

2. The electronically controlled mechanical timepiece according to claim 1, wherein
the connection circuit is switched to:
the first state when a voltage of the first power storage device is equal to or higher than a first threshold voltage and a voltage of the second power storage device is equal to or higher than a second threshold voltage as the first case,
the second state when the voltage of the first power storage device is equal to or higher than the first threshold voltage and the voltage of the second power storage device is less than the second threshold voltage as the second case, and
the third state when the voltage of the first power storage device is less than the first threshold voltage as the third case.

3. The electronically controlled mechanical timepiece according to claim 1, wherein
the connection circuit includes a switch that connects the first power storage device and the second power storage device,
the switch is configured by a metal-oxide-semiconductor field-effect transistor, and adjusts the amount of electric charge transfer depending on a voltage level of a control signal inputted to a gate of the metal-oxide-semiconductor field-effect transistor, and
the voltage level of the control signal inputted to the gate in the second state is a voltage level in a weak inversion region of the metal-oxide-semiconductor field-effect transistor.

4. The electronically controlled mechanical timepiece according to claim 1, wherein
the connection circuit includes:
a third power storage device having a capacitance smaller than that of the first power storage device;
a first switch that connects the first power storage device and the third power storage device; and
a second switch that connects the third power storage device and the second power storage device, and
the second state is a state in which a first opening/closing state and a second opening/closing state are alternately repeated,
the first opening/closing state indicating that the first switch is connected and the second switch is disconnected,
the second opening/closing state indicating that the first switch is disconnected and the second switch is connected.

5. The electronically controlled mechanical timepiece according to claim 4, wherein
the second state has a period during which both the first switch and the second switch are disconnected from each other, the period being provided between a first period during which the first opening/closing state is held and a second period during which the second opening/closing state is held.

6. The electronically controlled mechanical timepiece according to claim 1, further comprising:
an oscillator that outputs an clock signal; and
an oscillation stop detector that detects a stop of the oscillator, wherein
the connection circuit is switched to the third state when the oscillation stop detector detects the stop of the oscillator.

7. The electronically controlled mechanical timepiece according to claim 1, further comprising
a detector that detects electric energy generated by the generator, wherein
the connection circuit changes the amount of electric charge transfer per unit time in the second state according to the electric energy detected by the detector.
